(19) United States
(12) Patent Application Publication
(10) Pub. No.: US 2025/0338075 A1
(43) Pub. Date: Oct. 30, 2025

(54) MANAGING AUDIO PRESENTATION BASED ON LISTENER BACKGROUND

(71) Applicant: GOOGLE LLC, Mountain View, CA (US)

(72) Inventor: Dongeek Shin, San Jose, CA (US)

(21) Appl. No.: 19/195,017

(22) Filed: Apr. 30, 2025

Related U.S. Application Data
(60) Provisional application No. 63/640,487, filed on Apr. 30, 2024.

(51) Int. Cl. H04S 7/00

(52) U.S. Cl. CPC H04S 7/302; H04S 7/305; H04S 7/40

(57) ABSTRACT

According to at least one implementation, a method includes receiving at least one image of a listener environment. The method further includes applying a model to the at least one image to determine an audio response for the listener environment. The method also includes generating updated audio based on audio received from a device and the audio response.

### CROSS-REFERENCE TO RELATED APPLICATION

This application claims the benefit of U.S. Provisional Application No. 63/640,487, filed Apr. 30, 2024, the disclosure of which is incorporated herein by reference in its entirety.

### BACKGROUND

Video calling is a form of real-time communication that allows users to transmit audio and visual information over a network, enabling face-to-face interaction between participants in different locations. Video calling can use digital compression and transmission protocols to capture, encode, transmit, and decode audiovisual signals, typically facilitated by devices equipped with cameras, microphones, and displays, such as smartphones, computers, or dedicated conferencing systems. This technology enhances remote communication by conveying facial expressions, gestures, and other non-verbal cues, making the technology widely applicable in personal, professional, educational, and telehealth contexts.

### SUMMARY

This disclosure relates to systems and methods for updating an audio presentation based on the physical background of a listener. In some implementations, a system can be configured to receive audio data from a device. The system can further be configured to receive at least one image of the listener's physical environment and apply a model to the at least one image to determine an audio response for the listener's environment. In some implementations, the audio response can include acoustic properties, such as echo, reverberation, diffusion, and absorption. The system can be configured to use the audio response to generate updated audio from the received audio.

In some aspects, the techniques described herein relate to a method including: receiving at least one image of a listener environment; applying a model to the at least one image to determine an audio response for the listener environment; and generating updated audio (i.e. updated audio signal) based on audio (i.e., and original audio signal) received from a device and the audio response.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: receiving at least one image of a listener environment; applying a model to the at least one image to determine an audio response for the listener environment; and generating updated audio based on audio received from a device and the audio response.

In some aspects, the techniques described herein relate to a computer-readable storage medium storing executable instructions that when executed by at least one processor cause the at least one processor to execute a method, the method including: receiving at least one image of a listener environment; applying a model to the at least one image to determine an audio response for the listener environment; and generating updated audio based on audio received from a device and the audio response.

The accompanying drawings and the description below outline the details of one or more implementations. Other features will be apparent from the description, drawings, and claims.

### BRIEF DESCRIPTION OF THE DRAWINGS

FIG. 1 illustrates a computing environment for modifying an audio presentation based on the environment of a listener according to an implementation.

FIG. 2 illustrates a method of modifying an audio presentation based on the physical background of a listener according to an implementation.

FIG. 3 illustrates an operational scenario of modifying an audio presentation according to an implementation.

FIG. 4 illustrates an operational scenario of subtracting a user for determining audio response of an environment according to an implementation.

FIG. 5 illustrates an operational scenario of modifying an audio presentation for multiple environments according to an implementation.

FIG. 6 illustrates an operational scenario of modifying audio from multiple presenters according to an implementation.

FIG. 7 illustrates a computing system to modify an audio presentation according to an implementation.

### DETAILED DESCRIPTION

Video calling allows two or more people to see and hear each other in real-time using electronic devices such as smartphones, tablets, computers, or video conferencing systems. Each person's device uses at least one camera to capture live video and at least one microphone to capture their voice. This information is turned into digital signals and sent to the other person's device via the internet or another communication network. At the same time, each device receives video and audio signals from the other person's device, which are decoded and played through the screen and speakers. This allows for a live, face-to-face conversation even when users are in different locations. For example, two employees working in different cities might use video calling to have a virtual meeting about a project they are collaborating on. During the call, they can discuss progress, share their screens to show documents or presentations, and make decisions together in real time without needing to meet in person. This helps them stay connected and productive, even from separate locations. However, at least one technical problem exists in providing immersive audio on the listener side of a video call.

Audio issues on the listener side of a video call can encompass a range of challenges that hinder effective communication. These issues may include poor sound quality, characterized by distortions, echoes, or muffled speech, causing difficulties for listeners to comprehend the conversation. Additionally, during a conversation, the listener may fail to engage in a video conference or may not process the video conference in a preferred manner due to changes in the sound associated with the video conference and the physical room. For example, a person speaking in the same room as the listener will provide a first sound profile, while a second person speaking in the video conference may provide a second sound profile. This second sound profile can include different acoustic properties, such as echo, reverberation, absorption, or diffusion. This presents a technical problem of enabling a user in a video conference to be immersed in the conversation as if they were in the same room as the speaker.

As at least one technical solution, a computing system may identify attributes associated with the listener's environment and update a speaker's audio to make the remote speaker (e.g., video call participant) sound local to the listener's environment. For example, a computing device will use a camera system to identify image data of a listener's environment and process the image data to determine modifications to the audio output for the environment. The modifications are used to make a speaker (e.g., another party to the video call) sound local to the environment based on audio properties identified from the physical objects and environment of the listener.

In some implementations, the system can identify one or more images of the listener environment and apply a model to the one or more images to determine an audio response for the listener environment. The images can be processed using a model (including computer vision techniques) that identify spatial features, such as room dimensions, surface materials, and/or the presence of objects that may affect sound reflection and absorption. Based on the analysis of the model, the system can be configured to generate an audio response (e.g., including an acoustic model) representing the listener environment. The audio response can be applied to received audio data to generate updated audio data. In some implementations, the audio response can modify acoustic properties or features in the received audio.

For example, a first user on a first device can be in a small office, while a second user on a second device is in a large conference room. The first device can use one or more cameras to gather image data of the small office for the first user and apply a model to the image data to determine an audio response associated with the small office. The model can identify physical or spatial features in the office and associate the features with elements of the audio response. In some implementations, the audio response can modify one or more acoustic features of the received audio from the second device. In some examples, an acoustic feature can include an echo property in the audio (i.e., a feature in audio for the delayed repetition of sound caused by reflection off surfaces). In some examples, an acoustic feature can include a reverberation property in the audio (i.e., a feature in audio that is the persistence of sound caused by many rapid reflections overlapping after the original sound ends). In some examples, an acoustic feature can consist of an absorption property of the audio (i.e., how materials reduce sound energy by converting it into heat, decreasing reflections). In some examples, an acoustic feature can include a diffusion property of the audio (i.e., how sound moves through an environment after hitting one or more surfaces). Once the audio response is generated for the small office, the audio response can be applied to received audio from the large conference room to provide audio that closer represents the speaker being in the small office (i.e., provide a speech-in-listener-room effect). As at least one technical effect, the listening user can have a more immersive experience of the audio from the remote speaker. Although demonstrated as determining an audio response associated with an office, similar operations can be performed for other listener environments, including other types of rooms, outdoor spaces, and the like.

In some implementations, a camera system comprising one or more cameras captures images (i.e., corresponding to image data) of the environment and provides the image data to a computing device. The one or more cameras can be part of the computing device in some examples. The computing device identifies the image data and determines environmental information (i.e., spatial features) from the image data. The environmental information may include object information, such as the types, materials, and/or size of the objects. The environmental information may further include the orientation of the objects, such as the distance of the objects relative to one another and/or the capturing camera system, rotation information of the objects, or some other information. Once the environmental information is identified, the computing system can generate updated audio based on the environmental information. The updated audio may simulate the speech-in-listener-room effect, including reverberation updates, echoes, attenuation, and/or spatialization. These traits may be influenced by factors such as the size, shape, and/or materials of the environment, as well as the presence of objects and surfaces within it, all of which contribute to the way sound waves propagate and interact within the environment.

In at least one implementation, the system may use a transformer model with an encoder and decoder to determine the audio response of the environment. The encoder is used to extract and compress key features of the listener's physical environment from the image data, such as room shape and surface materials, into a latent representation that can guide realistic audio rendering. A latent representation can comprise a vector and is described as “latent” because it is an internal representation that captures the underlying features and patterns from the image data. The encoder is used in a transformer model to process raw input data, such as images, and transform the data into a latent representation, a compact and meaningful summary of the most important information. The encoder can do this by passing the input through a series of mathematical operations, such as neural network layers (like convolutional, recurrent, or fully connected layers), that gradually reduce the data's size while preserving its most relevant features. During this process, the encoder can be configured to filter out noise, identify patterns, and compress high-dimensional input into a lower-dimensional space (e.g., as a vector).

In some examples, the encoder takes image data that represents the physical characteristics of the listener's environment. The encoder processes the visual and/or spatial features and compresses them into a latent representation that captures the room's acoustic profile. A latent representation is a compressed, abstract version of input data (e.g., image data) created by the encoder that captures the most important features or patterns in that data. Instead of storing every detail, the latent representation holds the essential information needed to determine or reconstruct the original input. For example, a physical environment's shape and acoustic properties without the full image. In some examples, this can include room geometry (size and shape), surface materials, objects or obstacles, depth and distance for the objects or obstacles, and the like. The system may also identify the position of the listener in the environment.

In some implementations, the encoder can receive 3D information for the environment gathered from multiple cameras (and depth sensors) that can provide a 3D visualization of the environment. The multiple cameras or captured images can be used to provide additional spatial information, such as depth and location information associated with the various objects in the environment. Additionally, the use of multiple images can give more detail about the different materials related to the objects in the environment.

In addition to the encoder, a decoder may generate a room response (or audio response) that can modify the original audio provided by the transmitting device. The decoder takes a latent representation and transforms the representation into a more detailed, structured output, such as a receiver-side audio response. It does this by gradually expanding or interpreting the compressed features through a series of neural network layers, which can be in the reverse structure of the encoder. These layers learn how to map the simplified data back into a desired format while preserving the meaning or intent captured in the latent representation.

In some examples, the decoder uses the latent room representation to generate or simulate an audio response. For example, the decoder can output a digital filter, impulse response, or a spatial audio effect. This generated response can be applied to received audio (e.g., a voice from a remote speaker) through convolution or spatial rendering. As a technical effect, the remote audio is transformed to sound as if produced inside the listener's room, making the sound acoustically match the local environment.

In at least one implementation, the model can be configured (e.g., trained) to process images of a listener's physical environment and update remote audio to make the audio sound local. The configuration process can use a dataset that includes pairs of room images (or 3D environment models) and their corresponding acoustic responses, such as impulse responses or processed example audio. The model first can be configured to analyze visual features from the pictures, like room dimensions, wall and floor materials, the presence of furniture, and the like, that influence how sound behaves in the space. The model then maps these features to a set of acoustic characteristics, which generate filters or transformations that can be applied to incoming (i.e., received) audio. By comparing the model's audio output with actual or simulated ground-truth audio responses during training, the model gradually learns to produce realistic, spatially accurate sound. As at least one technical effect, the model can adapt remote audio to blend naturally into the listener's environment, enhancing the sense of presence and realism. Thus, when a new, unseen environment is captured, the features of the environment (size, materials, objects, locations, etc.) can be associated or mapped to an acoustic or audio response.

In some implementations, the model can be configured using a dataset containing pairs of visual data (e.g., images or depth maps of environments from depth sensors) and corresponding impulse responses. The impulse responses characterize how sound reflects and decays within the corresponding environment. The model can use a convolutional neural network (CNN) to extract spatial and material features from the images, such as room geometry, surface textures, and furnishing density, to map these features to an impulse response representation. In some examples, the impulse response is predicted as a waveform, while in other examples, it can be represented as a parametric model (parameters that describe acoustic features like reverberation time, early reflection delays, and absorption coefficients) or a spectro-temporal profile. The spectro-temporal profile impulse response can show how the frequencies change over time, like a picture that captures what pitches are present and how long they last or fade. This can describe how a room affects different sound parts as the sound travels and reflects.

During the configuration process, the model reduces the difference between the predicted and the ground-truth impulse responses provided for each of the environments. The reduction can use time-domain error, frequency-domain discrepancies, perceptually informed metrics, or other metrics. The system can use images of different environments with different dimensions, furniture, lighting, and the like to configure the model. In some implementations, the system can also use different imaging that can provide different lighting, image noise, occlusions, and the like. The different variables can be used during the configuration process to provide variations associated

In some implementations, the model can be configured to use volume pixels (voxels) identified from the images of the environment and process the voxels to determine the audio response. A voxel is the 3D equivalent of a pixel, representing a value in 3D space. Here, a voxel can capture spatial information in depth, height, and width, allowing the process to learn from 3D structures associated with the environment. The voxels for the 3D representations can be derived from a set of images or multi-view capture in some examples. The features associated with the environment can be derived from the voxels rather than 2D pixels associated with the environment, where voxels can provide depth information for the environment. The voxels can be tokenized (i.e., turned into a vector that represents the various information about the voxel) and processed using the encoding and decoding operations described above. Tokenizing can take the information from one or more voxels and generate a vector to include the relevant information for determining the audio response. The relevant information can indicate objects, materials, position, and other attributes for the one or more voxels. The tokenizing of the voxels can permit a model to use a more complete structure of the 3D structure of the environment.

In some examples, rather than voxels, a system can use point clouds, meshes, or other 3D structuring operations to define a 3D structure of an environment. For example, a system can capture multi-view images associated with an environment and generate a point cloud associated with the environment. A point cloud is a collection of points in 3D space, where each point represents a spot on the surface of objects or structures in an environment, typically defined by x, y, and z coordinates. The point cloud can be derived from images using methods like stereo vision (comparing two or more images from different angles to estimate depth), structure from motion (SfM) (using multiple images taken from different viewpoints to reconstruct 3D structure), or by using RGB-D cameras that capture both color and depth data. These techniques analyze the differences between images to calculate the distance of each visible point from the camera, building a 3D map of the scene as a point cloud. The point cloud can be provided to the model, and the model can determine an audio response associated with the environment. In some implementations, the model can be configured (i.e., trained) using point clouds paired to known audio responses for different environments. The model can process the point clouds to determine audio responses and then compare the determined audio responses to the ground-truth responses. Over a period of testing (e.g., changing parameters in the model over iterations), the model can be improved, such that the determined audio responses more closely align to the ground-truth responses. For example, the model can associate a first point cloud characteristic with a characteristic in the audio response. Although demonstrated using point clouds, similar operations can also be performed using meshes (3D models made of connected points (vertices) and surfaces (e.g., triangles) that form the shape of objects or environments, signed distance fields (represents a 3D environment by storing the distance from each point to the nearest surface, with the sign indicating whether the point is inside or outside the object), depth maps and camera poses, or another 3D environmental modeling technique. The models can be generated from multi-camera capture in some examples.

In some implementations, in addition to using the imaging data of the user's physical environment, the system can also use test sounds to improve the impulse response of the environment. For example, the system can generate sounds via one or more speakers and capture audio using one or more microphones. Based on the audio captured relative to the audio generated, the system can supplement the image information for producing the audio response or impulse response of the environment. For example, the captured audio can identify information associated with echo properties in the environment or reverberation properties of the environment. The information can provide supplemental information associated with materials or size of the environment. In some implementations, the model can be configured using both imaging data and sound data associated with environments. For example, instead of configuring the model with images paired with ground-truth impulse responses for environments, the model can be configured using images and test audio for an environment paired with ground-truth impulse responses. The model can, over a period of testing, reduce the error of a determined impulse response from images and audio testing to the ground truth for the same environment. The model can update values or weights in the model, such that different features (e.g., size of the room, tables, recorded sounds, and the like) can provide a different influence on the overall audio response of the environment.

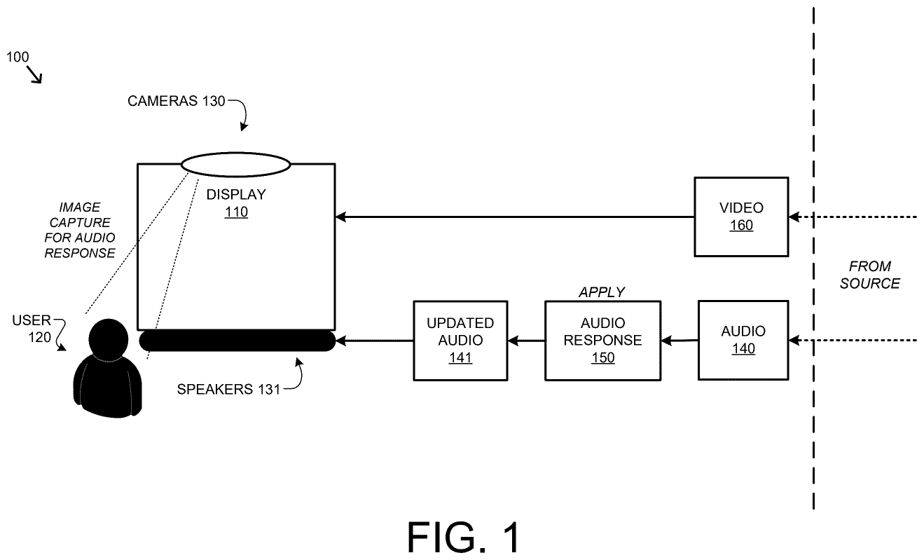

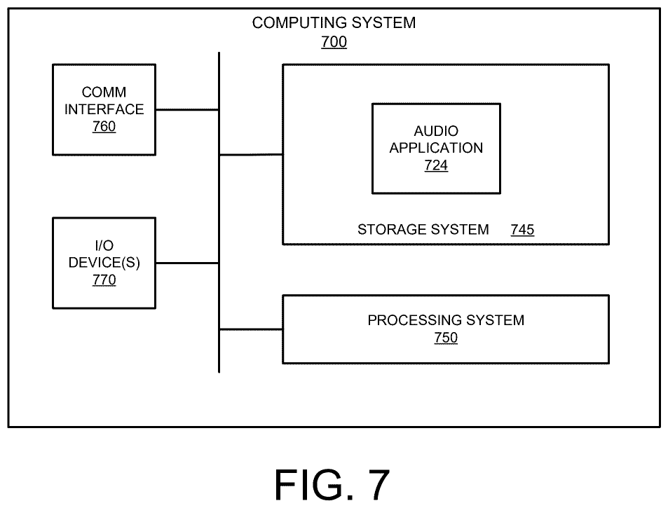

FIG. 1 illustrates a computing environment 100 for modifying an audio presentation based on a listener's environment according to an implementation. Computing environment 100 demonstrates a device receiving audio 140 and video 160 from a network and updating the audio to provide audio that seems local to user 120. Computing environment 100 includes display 110, user 120, cameras 130, speakers 131, audio 140, updated audio 141, audio response 150, and video 160. Smartphones, tablets, computers, or video conferencing systems can perform the operations depicted in computing environment 100. In some implementations, the operations of computing environment 100 can be performed by computing system 700 of FIG. 7.

In computing environment 100, audio 140 and video 160 are received from a network device. In some examples, audio 140 and video 160 can include video call data. A video call is a real-time conversation between people using devices with cameras and microphones, allowing them to see and hear each other over the Internet or another network. Video calls can be used for personal chats, work meetings, or long-distance communication. In some examples, audio 140 and video 160 can include a presentation streamed or obtained over a network. For example, a lecture can be recorded and distributed to user devices for viewing. Although demonstrated as being received over a network, the audio and video can be a local recording of a presenter. Further, while shown in computing environment 100 as being received with video, audio 140 can be obtained exclusively in some examples.

After audio 140 is received, the system can apply audio response 150 to generate updated audio 141. Updated audio 141 can be provided to user 120 via speakers 131, while video 160 is provided via display 110. In some implementations, audio response 150 represents how sound behaves in the specific physical environment for user 120, capturing characteristics like reverberation, echo, and/or spatial diffusion that occur as sound waves interact with the room's surfaces and layout. Audio response 150 can reflect the unique way a space modifies sound, depending on room size, geometry, materials (e.g., carpet, wood, glass), or other factors. This response can be expressed mathematically as an impulse response or as a set of filters and effects that modify audio to simulate the experience of hearing the audio within that environment. When applied to audio 140, the response makes audio 140 sound as though the audio is being played or spoken within the space, creating a more immersive and realistic listening experience for user 120. In some implementations, the audio response can modify one or more acoustic features of the received audio from the second device. In some examples, an acoustic feature can include an echo property in the audio. In some examples, an acoustic feature can include a reverberation property in the audio. In some examples, an acoustic feature can consist of an absorption property of the audio. In some examples, an acoustic feature can include a diffusion property of the audio. The device can receive audio 140 that contains one or more of the acoustic features and apply audio response 150 to generate updated audio 141 that includes one or more modified versions of the acoustic features. For example, the device can apply audio response 150 to provide additional echo associated with the user's environment. As a result, while the first environment can capture audio associated with a first set of acoustic features (e.g., echo, reverberation, etc.), audio response 150 can update the first set of acoustic features to a second set of acoustic features associated

In some implementations, audio response 150 is generated using a model. The model generates the audio response by first analyzing input data, such as images or spatial information from the environment of user 120, using an encoder that extracts key visual and structural features related to how sound would behave in the space. The features can include elements of a room captured in images that affect how sound behaves, such as room size, shape, and surface materials like wood, carpet, glass, or some other material. They also include objects like furniture, windows, and doors, influencing sound reflection, absorption, and/or diffusion within the space. These features are transformed into a latent representation that captures the room's estimated acoustic properties, like reverberation time, echo patterns, and/or sound diffusion. A decoder then uses this representation to create audio response 150.

In some examples, cameras 130 can capture one or more images of the physical environment associated with user 120. In some examples, cameras 130 can provide a multi-view capture of the listener environment. Multi-view capture is a technique where a scene or object is recorded from multiple camera angles or viewpoints simultaneously, allowing for a more detailed 3D construction of its shape, appearance, and spatial relationships. After the images are captured, the system can perform an operation to remove user 120 from the image of the environment to improve the identification of the physical objects of the space. In some implementations, the system can use software to detect portions of user 120 in the images and replace the portions with pixels that predict the user's background. In some implementations, cameras 130 can also capture one or more images without user 120 located in the frame. For example, the system can prompt the user to vacate the frame captured by cameras 130. The system can then be configured to take one or more images of the environment without the presence of user 120. The information from the images can be used to configure audio response 150 to support local-sounding audio in the environment of user 120.

In some implementations, the location of the user relative to the environment can be determined from the images and processed by the model to determine the audio response for the listener. For example, if the user is in a first location in the environment, the audio may require a first response (e.g., first echo characteristics). In contrast, in a second location in the environment, the audio may require a second response. In some examples, the location of the user can be presumed based on a typical user experience with the device (e.g., sitting in front of a computer).

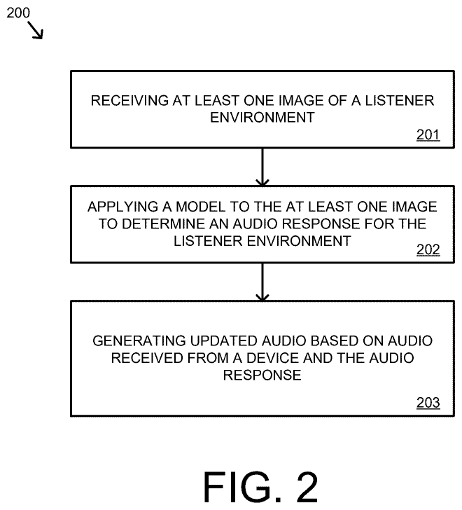

FIG. 2 illustrates method 200 for modifying an audio presentation based on the physical background of a listener according to an implementation. Method 200 can be performed by one or more computing devices, such as smartphones, tablets, laptop computers, desktop computers, or other computing devices. In some implementations, method 200 can be performed by computing system 700 of FIG. 7.

Method 200 includes receiving at least one image of a listener environment at step 201. Method 200 further includes applying a model to the at least one image to determine an audio response for the listener environment at step 202. In some implementations, the model can be configured or trained using a dataset of images or spatial data from various physical environments paired with corresponding audio responses that reflect how sound behaves in those spaces. During a configuration process (e.g., training), the model's encoder can identify visual and structural features from input images and compress them into a latent representation (i.e., a simplified form of the input image data that captures the most important features). In some implementations, the features include room size, shape, and/or materials of the environment. The decoder then uses this representation to generate an audio response, like an impulse response or filter, that simulates the acoustic behavior of the environment. Using a loss function, the system can be configured to minimize the difference between generated audio and the ground-truth audio response, allowing the model to learn how different features influence sound. As testing progresses, the model can generalize different environmental characteristics to generate audio responses for new environments.

For example, a system can capture a picture of a user's office to identify features associated with the environment. The system can detect the size and shape of the room based on walls, floor, and ceiling boundaries, recognize various materials in the environment, including carpet, wood, or glass from texture and color, and identify objects, like desks, chairs, and bookshelves that can affect how sound is reflected or absorbed. The visual patterns can be converted to numerical features that represent the office's acoustic properties and can be used to generate the audio response.

Once the audio response is generated, method 200 further includes generating updated audio based on audio received from a device and the audio response at step 203. In some implementations, the system can apply the audio response (or impulse response) by using convolution that blends the original presenter input (i.e., voice) with the impulse response of the listener environment (e.g., office). This can change the sound such that the sound or audio carries the natural effects of the listener's space, like echoes in a small office, making the voice appear to come from the listener's room or environment. Convolution is a mathematical operation that combines two signals to produce a third signal that shows how one affects the other over time. The two signals include the original audio from the presenter and the impulse response (i.e., audio response) of the environment. Here, convolution can be used to apply the effect of an environment, like echo or reverb, by blending an input sound with an impulse response that represents the space.

In some implementations, rather than exclusively using the imaging data associated with the environment, the system can further be configured to use test audio to determine the impulse response. For example, the system can generate sounds via one or more speakers and capture audio using one or more microphones. Based on the audio captured relative to the audio generated, the system can supplement the image information for producing the environment's audio response or impulse response. For example, the captured audio can identify information associated with echo properties in the environment or reverberation properties of the environment. The information can provide supplemental information associated with materials or the size of the environment.

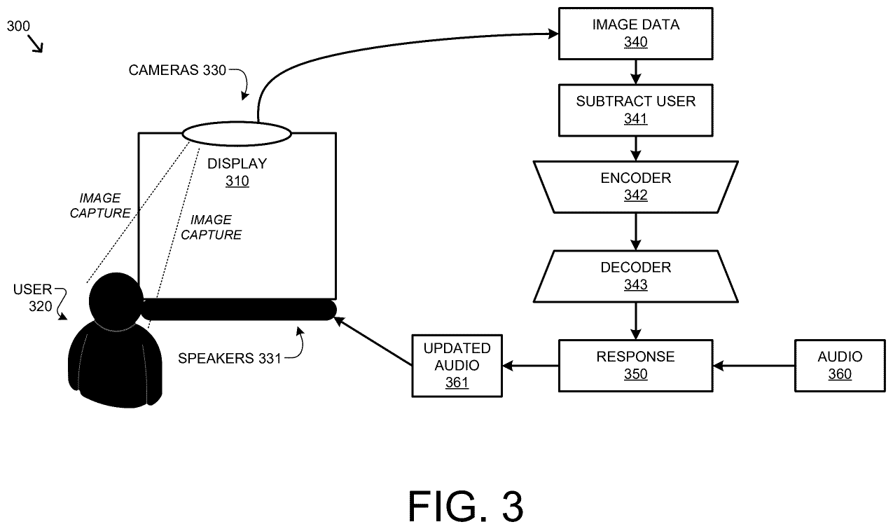

FIG. 3 illustrates an operational scenario 300 of modifying an audio presentation according to an implementation. A computing system, such as a desktop computer, laptop computer, tablet, or some other computing system can implement operational scenario 300. Operational scenario 300 includes display 310, user 320, cameras 330, speakers 331, image data 340, subtract user 341, encoder 342, decoder 343, response 350, audio 360, and updated audio 361. In some implementations, encoder 342 and decoder 343 can represent different portions of a transformer model. In a transformer model, the encoder processes input data (like one or more images from cameras 330) by extracting features and representing them as embeddings that capture meaning and context. The features can include visual cues via RGB information (e.g., chairs, bookshelves, etc.) and depth information associated with the objects. The decoder takes this encoded information and generates output, such as a predicted response audio response for the user's environment, which can focus on relevant parts of the input.

In operational scenario 300, a computing system captures image data 340 using cameras 330. Cameras 330 can include one or more cameras capable of capturing images of a user environment. In some implementations, cameras 330 can capture the environment without user 320. For example, the system can provide a prompt via display 310 that user 320 vacate the frame captured by cameras 330. In some implementations, cameras 330 can capture the environment with user 320 in the frame. After capturing image data 340, operational scenario 300 performs subtract user 341, which can remove the user from image data 340. In some examples, the system can be configured to find and outline the user in image data 340. The system can then remove the masked area and apply an algorithm to fill the missing region using surrounding pixels. This can predict the background based on the pixels near the location of the removed user 320. In some implementations, cameras 330 can capture multiple images of the environment that can provide additional 3D information associated with the environment. In some examples, the images can assist in replacing portions of the frame with the user. In some implementations, multiple images can be used to generate a 3D representation of the environment using voxels. Voxels create a 3D representation of an environment by dividing the space into a grid of small cubes, where each cube (voxel) holds information about what is inside that part of the space, like whether the space is empty, solid, or what material corresponds to the space. When combined, the voxels can form a 3D representation of the environment. This can be created using the set of images from cameras 330.

Once the user is removed from image data 340, the system performs encoder 342. Encoder 342 can be used to identify environment attributes from image data by identifying visual features that correlate with acoustic characteristics. Encoder 342 can extract features like room geometry, surface materials, furniture, textures, or other information from image data 340 (in some examples, without user 320). The visual features are linked to how sound behaves in the environment or space. For example, hard surfaces can reflect sound, while soft materials can absorb sound.

In some implementations, encoder 342 can use voxel tokenization of image data 340. Voxel tokenization can divide a 3D representation of the environment of user 320 into smaller cubic units called voxels that each contain local geometric and/or material information. The 3D representation can be constructed from 3D images from cameras 330, LiDAR, or from another source. The voxels can be converted into tokens, including fixed-size embeddings that encode spatial position, surface type, or other features of the voxels. By feeding these voxel tokens into a transformer (i.e., encoder 342) or another similar model, the system can identify spatial relationships and patterns relevant to audio in the environment of user 320. Like the operations above, encoder 342 can process the tokenized voxels to determine the geometry, material properties, or other relevant information associated with the audio in the environment. In some implementations, encoder 342 can compress the information from the tokenized voxels into a feature vector. The feature vector can be a list of numerical values that represents important characteristics or patterns extracted from raw input data, like an environment's shape and materials.

Once the features are extracted from image data 340, decoder 343 can generate response 350, which is representative of an audio response or impulse response. Decoder 343 can take the encoded representation from encoder 342 (from image or voxel tokens) and translates the encoded information into a meaningful output, such as an audio response 350. Decoder 343 can expand or interpret the compressed information from encoder 342, using layers (like fully connected layers, transformers, and the like) to map the learned features back to a useful response 350. For example, decoder 343 can output response 350, which can include information about reverberation or absorption associated with the environment.

The system can apply response 350 to audio 360 to generate updated audio 361 that can be played via speakers 331. In some implementations, audio 360 can be stored locally on the computing system (e.g., a user computing device). In some implementations, audio 360 can be received from a second computing device. For example, audio 360 can be received as a part of a presentation or video call from a second computing device. In some implementations, in applying response 350, the system can employ convolution. Convolution is the process of embedding the environment's acoustic characteristics into the voice. This can add reverberation, spatial cues, or other environmental features, making the sound seem as though it was recorded in that room (or the speaker is speaking in the room). For example, while audio 360 can be recorded in a large auditorium, response 350 can be applied to the (original) audio 360 via convolution to generate updated audio 361 and make updated audio 361 sound as if the audio originated in a smaller office or environment for user 320.

Although demonstrated in the previous example using voxels, a system can use point clouds, meshes, or other 3D structuring operations to define a 3D structure of an environment. For example, a system can capture multi-view images associated with an environment and generate a point cloud associated with the environment. A point cloud is a collection of points in 3D space, where each point represents a spot on the surface of objects or structures in an environment, typically defined by x, y, and z coordinates. The point cloud can be derived from images using methods like stereo vision (comparing two or more images from different angles to estimate depth), structure from motion (SfM) (using multiple images taken from different viewpoints to reconstruct 3D structure), or by using RGB-D cameras that capture both color and depth data. These techniques analyze the differences between images to calculate the distance of each visible point from the camera, building a 3D map of the scene as a point cloud. The point cloud can be provided to the model, and the model can determine an audio response associated with the environment. In some implementations, the model can be configured (i.e., trained) using point clouds paired to known audio responses for different environments. The model can process the point clouds to determine audio responses and then compare the determined audio responses to the ground-truth responses. For testing (e.g., changing parameters in the model over iterations), the model can be improved, such that the determined audio responses more closely align with the ground-truth responses. For example, the model can associate a first point cloud characteristic with a characteristic in the audio response. Although demonstrated using point clouds, similar operations can also be performed using meshes, signed distance fields, depth maps and camera poses, or another 3D environmental modeling technique. The models can be generated from multi-camera capture in some examples.

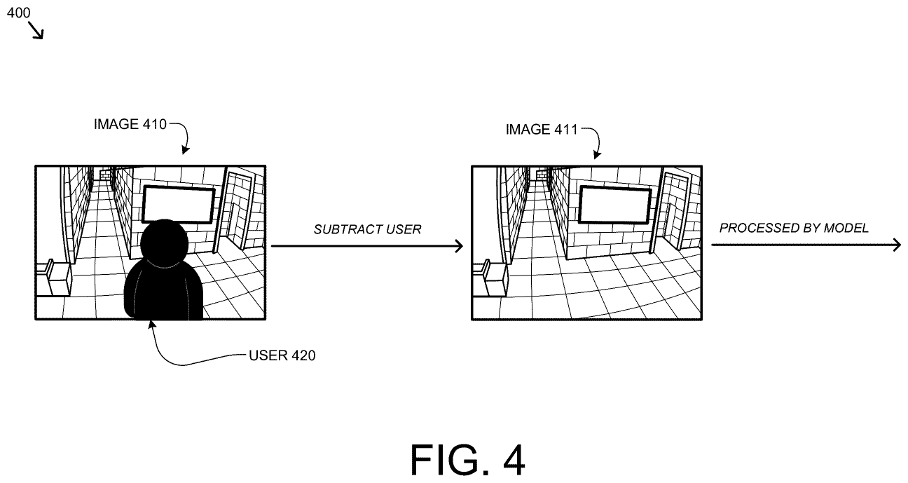

FIG. 4 illustrates an operational scenario 400 of subtracting a user to determine an audio response of an environment according to an implementation. Operational scenario 400 includes image 410 with user 420 and image 411. In operational scenario 400, a computing system can capture image 410 (and one or more additional images) using a camera or camera system. To define an audio response (e.g., impulse response), image 410 can be processed to remove user 420 to provide image 411.

In some implementations, the system device can remove user 420 from image 410 images by identifying the location of user 420 using image processing techniques or object identification techniques. The system then covers that area (or masks it) and fills the area in using parts of the background from around user 420, such that an updated image 411 is created without the user's presence. Once the system generates image 411, image 411 is selected for processing by the model, which determines the audio response from the image. In some implementations, the system can employ multiple images or cameras that capture additional information about the background to fill in for portions where the user is present. For example, the system can support multi-view capture of the environment to identify additional information about the physical features. The multiple images can be used to identify different physical environment features or provide a more accurate interpretation of the user's background when the user is removed from the images.

Although demonstrated in the example of operational scenario 400 as removing user 420, some computing systems can prompt the user to vacate an area captured by the cameras of the system. The system can then use one or more cameras to capture one or more images that capture information about the user's environment. The captured images can be provided to an encoder in some examples that can extract relevant information from the images (e.g., size, textures, and the like) to determine the audio or impulse response associated with the environment.

In some implementations, a system can be configured to determine a location of the user or listener in the environment. The location of the user can change the audio response because sound travels through space, bouncing off walls, ceilings, and objects before reaching the listener. The timing, intensity, and direction of these reflections vary depending on where the listener is positioned. For example, standing near a wall might amplify certain echoes, while being in the center of a room might allow more direct sound and fewer early reflections. These differences can affect how the listener identifies spatial cues and alter the overall acoustic experience. In at least one implementation, the model described herein can identify the features of the user environment and can further determine the position of the user relative to the environment. This can be derived from multiple images in some examples. The location of the user can be encoded for the model, such that the model can use its configuration to update the audio response based on the listener location relative to the environment.

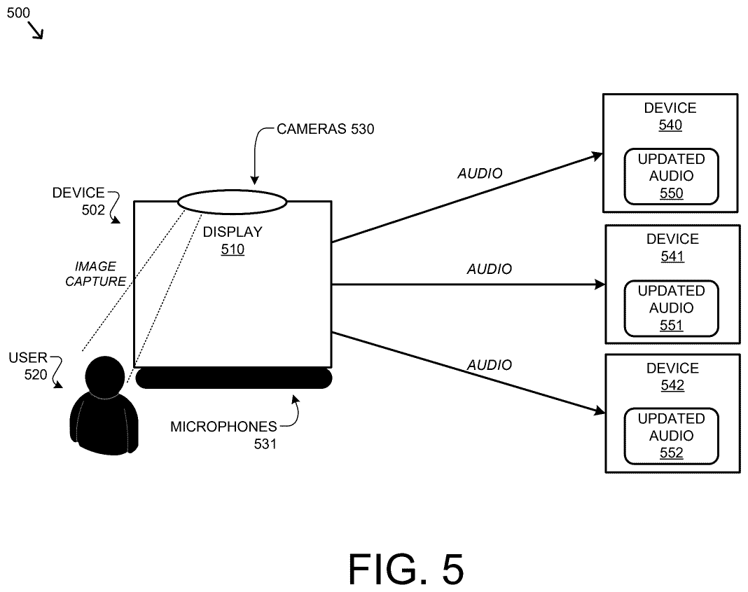

FIG. 5 illustrates an operational scenario 500 of modifying an audio presentation for multiple environments according to an implementation. Operational scenario 500 includes device 502, display 510, user 520, cameras 530, microphones 531, devices 540, 541, and 542, and updated audio 550, 551, and 552.

In operational scenario 500, device 502 captures audio of user 520 using microphones 531. Once captured, the audio, and in some examples video data from cameras 530, can be communicated to devices 540, 541, and 542. Each device of devices 540, 541, and 542 can be configured to capture one or more images of the physical environment associated with the corresponding device and use the one or more images to determine an impulse or audio response for the physical environment. For example, device 540 can identify first features associated with the physical environment for device 540 (e.g., echo and reverberation) and provide a first audio response, while device 541 can identify second features associated with the physical environment for device 541 and provide a second audio response. The differences in an environment can correspond to the size of the environment, the materials of the environment, objects in the environment, and the like. As a technical effect, devices 540, 541, and 542 can provide a different impulse response to modify the received audio to reflect the local physical environment.

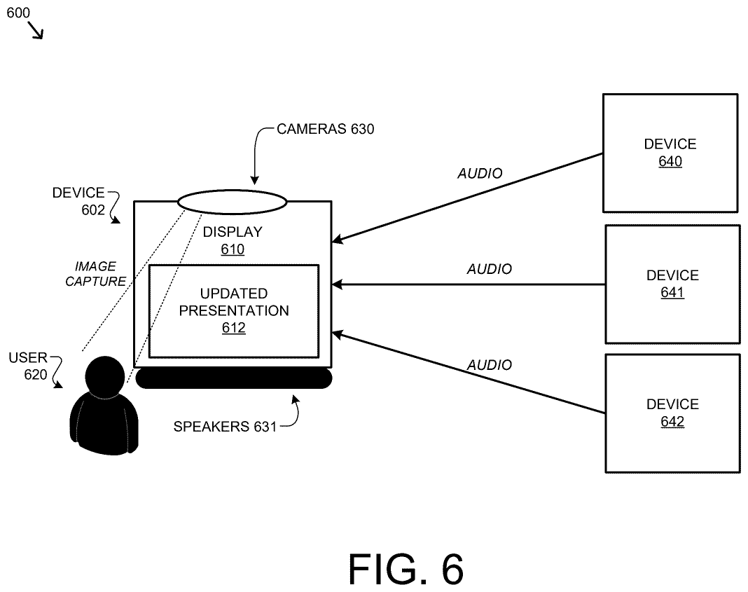

FIG. 6 illustrates an operational scenario 600 of modifying audio from multiple presenters according to an implementation. Operational scenario 600 includes device 602, display 610 with updated presentation 612, user 620, cameras 630, speakers 631, and devices 640, 641, and 642 that provide audio to device 602.

In operational scenario 600, device 602 receives audio corresponding to presentations from devices 640, 641, and 642. For example, each device of devices 640, 641, and 642 can correspond to other users as part of a video call with user 620. Video calls can offer a more engaging and effective communication by allowing users to see each other's expressions, gestures, and reactions. They can enhance clarity, reduce misunderstandings, and foster stronger personal or professional connections, especially when in-person meetings are impossible.

Here, cameras 630 capture one or more images associated with the physical environment of user 620. Device 602 (or an external computing system) can apply a model to the one or more images to determine an audio response for the listener environment. In some examples, the system can remove user 620 (if necessary) from one or more images before using the model. In some implementations, the images can include a multi-view capture associated with the listener environment. Multi-view images can capture a scene or object from multiple angles, providing a more complete and detailed representation. This can be useful for defining environments more accurately and generating a 3D model of the environment, including depth information associated with objects in the environment.

In some implementations, the system can identify spatial and material features from the environment's images, such as room shape, size, surface type, and/or object placement. The features can be input into a model configured with the relationship between visual characteristics and acoustic properties. The model can output an estimated impulse or audio response that reflects how sound would behave in that specific environment. The response can include details like the time taken for sound to reflect off surfaces, the strength of the reflections, and/or how the sound decays over time. The response can capture the acoustic characteristics of the environment, such as clarity, warmth, and/or spatial feel. For example, a first environment may correspond to a first impulse response because of first materials, and a second environment may correspond to a second impulse response because of second materials.

In some implementations, the system can determine voxels using a set of images for the environment. A voxel is a 3D grid-based unit representing the volume of the environment. By analyzing voxel data (e.g., features extracted into tokens), the model can identify the shape, size, and/or material properties of surfaces within the space. This information can then be used to simulate how sound waves interact with the environment, helping to generate accurate impulse responses based on reflections, absorption, and/or diffusion throughout the voxel-based environment. In some examples, the model can be configured on associations of imaging data to various sound profiles associated with the imaging data. This can help the model identify new and unseen environments and predict the audio response associated with the environment.

In some examples, the model can be configured using test images of different environments paired with ground-truth audio responses measured or determined for the environments. In some examples, in configuring the model, a system can convert the test images to meshes, voxels, point clouds, or other 3D representations of the environment. The testing process can determine audio responses from the 3D representations and, during testing, reduce the differences between the determined audio responses and the ground-truth audio responses. Once reduced, the model can be applied to a new environment, such as the environment associated with user 620. For example, the system can capture multiple images using cameras 630, and the images can be used to construct a 3D representation of the environment (e.g., using a point cloud). The 3D representation can be input to the model to determine the audio response associated with the environment of user 620.

In operational scenario 600, as the audio is received from devices 640, 641, and 642 and the audio response is applied to each of the streams. In some implementations, applying the audio response can include using convolution. Convolution can be used to simulate how the audio would sound in the specific physical environment associated with user 620. When the audio response (i.e., impulse response) is convolved with a received audio signal, the system applies the characteristics of the environment to the sound. This process blends the original audio with the environmental acoustics to create a more realistic and immersive experience for user 620. Once the model is applied to the received audio, the updated audio from devices 640, 641, and 642 can be provided via updated presentation 612. In some implementations, updated presentation 612 can include audio and video. For example, the updated audio can be provided with video associated with the remote device in a video call. In some implementations, each of devices 640, 641, and 642 can capture audio in a different environment (e.g., large conference room, small office, etc.). The model can be applied such that the audio is consistent for user 620 and provides a speech-in-listener-room effect.

Although demonstrated as being received from other devices, device 602 can process audio stored locally to provide the user with a more immersive experience. For example, the user may view a presentation, and the audio of the presentation can be updated to reflect the environment of user 620. Further, while demonstrated as using exclusively imaging to determine the audio response or impulse response associated with the environment, device 602 can be configured to determine the response using test audio. For example, speakers 631 can use test sounds to assess environmental characteristics associated with the environment. The model can be applied to the imaging of the environment and the test audio (captured through one or more microphones) to determine the audio response of the environment.

FIG. 7 illustrates a computing system 700 to modify an audio presentation according to an implementation. Computing system 700 is representative of any computing system or systems with which the various operational architectures, processes, scenarios, and sequences disclosed herein can be implemented to provide a speech-in-listener-room effect. Computing system 700 may represent a computer, a laptop, a tablet, or another device. Computing system 700 can include multiple computing devices in some examples. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with external devices, such as servers, user devices, or some other computing device. Communication interface 760 may be configured to receive audio data (and, optionally, video data) from at least one additional computing device. For example, communication interface 760 may receive audiovisual data associated with a video call.

I/O device(s) 770 may include peripherals of a computer that facilitate the interaction between the user and computing system 700. Examples of I/O device(s) 770 may include keyboards, mice, trackpads, monitors, displays, printers, cameras, microphones, external storage devices, and the like. In some implementations, at least one display is used to display audiovisual content. In some implementations, one or more cameras and microphones are used to capture audiovisual data for the device.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises audio application 724. The operating software on storage system 745 may further include an operating system, utilities, drivers, network interfaces, applications, or some other type of software. When read and executed by processing system 750 the operating software on storage system 745 directs computing system 700 to operate as described in FIGS. 1-6.

In at least one implementation, audio application 724 directs processing system 750 to receive at least one image of a listener environment and apply a model to the at least one image to determine an audio response for the listener environment. In some implementations, the model is configured or trained using a set of images associated with audio responses (or audio) associated with the images. The model can identify physical features corresponding to audio response changes. Once trained, the model is applied to the new or unseen environment to identify features and generate an audio response for the environment. In some implementations, the images include a multi-view capture of the environment to determine the depth and location of the different elements in the environment. In some examples, the model can include a transformer that processes features identified in the one or more images. In some examples, the computing system can determine voxels from the one or more images that are tokenized and provided to the model. The voxels can be used to identify audio characteristics associated with physical objects in the environment. In some examples, the model can include a transformer that correlates features identified in the various voxels to audio traits for an audio response.

In some examples, rather than voxels, a system can use point clouds, meshes, or other 3D structuring operations to define a 3D structure of an environment. For example, a system can capture multi-view images associated with an environment and generate a point cloud associated with the environment. A point cloud is a collection of points in 3D space, where each point represents a spot on the surface of objects or structures in an environment, typically defined by x, y, and z coordinates. The point cloud can be derived from images using methods like stereo vision (comparing two or more images from different angles to estimate depth), structure from motion (SfM) (using multiple images taken from different viewpoints to reconstruct 3D structure), or by using RGB-D cameras that capture both color and depth data. These techniques analyze the differences between images to calculate the distance of each visible point from the camera, building a 3D map of the scene as a point cloud. The point cloud can be provided to the model, and the model can determine an audio response associated with the environment. In some implementations, the model can be configured (i.e., trained) using point clouds paired to known audio responses for different environments. The model can process the point clouds to determine audio responses and then compare the determined audio responses to the ground-truth responses. For testing (e.g., changing parameters in the model over iterations), the model can be improved, such that the determined audio responses more closely align to the ground-truth responses. For example, the model can associate a first point cloud characteristic with a characteristic in the audio response. Although demonstrated using point clouds, similar operations can also be performed using meshes, signed distance fields, depth maps and camera poses, or another 3D environmental modeling technique. The models can be generated from multi-camera capture in some examples.

In some implementations, after the audio response is determined, audio application 724 directs processing system 750 to update the audio based on audio received from a device and the audio response. In some implementations, the audio is received from at least one second device as part of a presentation or video call. The audio response is then applied to the received audio to provide a speech-in-listener-room effect. In some implementations, applying the audio response can include using convolution to update the received audio to provide a speech-in-listener-room effect. As at least one technical effect, the listener can be more engaged in the presentation of the received audio.

For example, a user in an office setting can use a teleconferencing device (e.g., computing system 700) to communicate with other users in different environments. The device can capture images of the office and apply a model to determine an audio response associated with the environment. When audio is received as part of a video conference, the audio response is applied to the audio to make the voice of the speaker appear local to the office. In some implementations, the audio response can incorporate reverberation or echo into the audio to provide a more immersive experience for the listening user.

In some implementations, in using the model, computing system 700 can process multiple images that provide 3D information about the environment. The images can give depth, size, and/or material information associated with the environment that can correspond to different audio attributes like echo and reverberation. In some examples, in providing an input to the model, the system can determine voxels that represent the environment from the captured images and tokenize the voxels for the model. The tokenized voxels can be processed and mapped to an audio response associated with the environment.

Below are example clauses associated with the present disclosure. The described clauses should not be considered exhaustive.

Clause 1. A method comprising: receiving at least one image of a listener environment; applying a model to the at least one image to determine an audio response for the listener environment; and generating updated audio based on audio received from a device and the audio response.

Clause 2. The method of clause 1, wherein receiving the at least one image of the listener environment comprises: receiving a first image of the listener environment, the first image comprising a user; removing the user from the first image to generate a second image; and selecting the second image as the at least one image.

Clause 3. The method of clause 1, wherein receiving the at least one image of the listener environment comprises receiving a multi-view capture of the listener environment.

Clause 4. The method of clause 1, wherein the listener environment comprises a first environment, wherein the audio comprises a first echo property associated with a second environment, and wherein generating the updated audio comprises: updating the first echo property to a second echo property associated with the first environment.

Clause 5. The method of clause 1, wherein the listener environment comprises a first environment, wherein the audio comprises a first reverberation property associated with a second environment, and wherein generating the updated audio comprises: updating the first reverberation property to a second reverberation property associated with the first environment.

Clause 6. The method of clause 1, wherein the listener environment comprises a first environment, wherein the audio comprises a first absorption property associated with a second environment, and wherein generating the updated audio comprises: updating the first absorption property to a second absorption property associated with the first environment.

Clause 7. The method of clause 1, wherein the listener environment comprises a first environment, wherein the audio comprises a first diffusion property associated with a second environment, and wherein generating the updated audio comprises: updating the first diffusion property to a second diffusion property associated with the first environment.

Clause 8. The method of clause 1, wherein the model is configured based on additional images of one or more additional environments and audio properties associated with the one or more additional environments.

Clause 9. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: receiving at least one image of a listener environment; applying a model to the at least one image to determine an audio response for the listener environment; and generating updated audio based on audio received from a device and the audio response.

Clause 10. The computing system of clause 9, wherein receiving the at least one image of the listener environment comprises: receiving a first image of the listener environment, the first image comprising a user; removing the user from the first image to generate a second image; and selecting the second image as the at least one image.

Clause 11. The computing system of clause 9, wherein receiving the at least one image of the listener environment comprises receiving a multi-view capture of the listener environment.

Clause 12. The computing system of clause 9, wherein the listener environment comprises a first environment, wherein the audio comprises a first echo property associated with a second environment, and wherein generating the updated audio comprises: updating the first echo property to a second echo property associated with the first environment.

Clause 13. The computing system of clause 9, wherein the listener environment comprises a first environment, wherein the audio comprises a first reverberation property associated with a second environment, and wherein generating the updated audio comprises: updating the first reverberation property to a second reverberation property associated with the first environment.

Clause 14. The computing system of clause 9, wherein the listener environment comprises a first environment, wherein the audio comprises a first absorption property associated with a second environment, and wherein generating the updated audio comprises: updating the first absorption property to a second absorption property associated with the first environment.

Clause 15. The computing system of clause 9, wherein the listener environment comprises a first environment, wherein the audio comprises a first diffusion property associated with a second environment, and wherein generating the updated audio comprises: updating the first diffusion property to a second diffusion property associated with the first environment.

Clause 16. The computing system of clause 9, wherein the model is configured based on additional images of one or more additional environments and audio properties associated with the one or more additional environments.

Clause 17. A computer-readable storage medium storing executable instructions that when executed by at least one processor cause the at least one processor to execute a method, the method comprising: receiving at least one image of a listener environment; applying a model to the at least one image to determine an audio response for the listener environment; and generating updated audio based on audio received from a device and the audio response.

Clause 18. The computer-readable storage medium of clause 17, wherein receiving the at least one image of the listener environment comprises: receiving a first image of the listener environment, the first image comprising a user; removing the user from the first image to generate a second image; and selecting the second image as the at least one image.

Clause 19. The computer-readable storage medium of clause 17, wherein receiving the at least one image of the listener environment comprises receiving a multi-view capture of the listener environment.

Clause 20. The computer-readable storage medium of clause 17, wherein the listener environment comprises a first environment, wherein the audio comprises a first echo property associated with a second environment, and wherein generating the updated audio comprises: updating the first echo property to a second echo property associated with the first environment.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
receiving at least one image of a listener environment;
applying a model to the at least one image to determine an audio response for the listener environment; and
generating updated audio based on audio received from a device and the audio response.

2. The method of claim 1, wherein receiving the at least one image of the listener environment comprises:
receiving a first image of the listener environment, the first image comprising a user;
removing the user from the first image to generate a second image; and
selecting the second image as the at least one image.

3. The method of claim 1, wherein receiving the at least one image of the listener environment comprises receiving a multi-view capture of the listener environment.

4. The method of claim 1, wherein the listener environment comprises a first environment, wherein the audio comprises a first echo property associated with a second environment, and wherein generating the updated audio comprises:
updating the first echo property to a second echo property associated with the first environment.

5. The method of claim 1, wherein the listener environment comprises a first environment, wherein the audio comprises a first reverberation property associated with a second environment, and wherein generating the updated audio comprises:
updating the first reverberation property to a second reverberation property associated with the first environment.

6. The method of claim 1, wherein the listener environment comprises a first environment, wherein the audio comprises a first absorption property associated with a second environment, and wherein generating the updated audio comprises:
updating the first absorption property to a second absorption property associated with the first environment.

7. The method of claim 1, wherein the listener environment comprises a first environment, wherein the audio comprises a first diffusion property associated with a second environment, and wherein generating the updated audio comprises:
updating the first diffusion property to a second diffusion property associated with the first environment.

8. The method of claim 1, wherein the model is configured based on additional images of one or more additional environments and audio properties associated with the one or more additional environments.

9. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
receiving at least one image of a listener environment;
applying a model to the at least one image to determine an audio response for the listener environment; and
generating updated audio based on audio received from a device and the audio response.

10. The computing system of claim 9, wherein receiving the at least one image of the listener environment comprises:
receiving a first image of the listener environment, the first image comprising a user;
removing the user from the first image to generate a second image; and
selecting the second image as the at least one image.

11. The computing system of claim 9, wherein receiving the at least one image of the listener environment comprises receiving a multi-view capture of the listener environment.

12. The computing system of claim 9, wherein the listener environment comprises a first environment, wherein the audio comprises a first echo property associated with a second environment, and wherein generating the updated audio comprises:
updating the first echo property to a second echo property associated with the first environment.

13. The computing system of claim 9, wherein the listener environment comprises a first environment, wherein the audio comprises a first reverberation property associated with a second environment, and wherein generating the updated audio comprises:
updating the first reverberation property to a second reverberation property associated with the first environment.

14. The computing system of claim 9, wherein the listener environment comprises a first environment, wherein the audio comprises a first absorption property associated with a second environment, and wherein generating the updated audio comprises:
updating the first absorption property to a second absorption property associated with the first environment.

15. The computing system of claim 9, wherein the listener environment comprises a first environment, wherein the audio comprises a first diffusion property associated with a second environment, and wherein generating the updated audio comprises:
updating the first diffusion property to a second diffusion property associated with the first environment.

16. The computing system of claim 9, wherein the model is configured based on additional images of one or more additional environments and audio properties associated with the one or more additional environments.

17. A computer-readable storage medium storing executable instructions that when executed by at least one processor cause the at least one processor to execute a method, the method comprising:
receiving at least one image of a listener environment;
applying a model to the at least one image to determine an audio response for the listener environment; and
generating updated audio based on audio received from a device and the audio response.

18. The computer-readable storage medium of claim 17, wherein receiving the at least one image of the listener environment comprises:
receiving a first image of the listener environment, the first image comprising a user;
removing the user from the first image to generate a second image; and
selecting the second image as the at least one image.

19. The computer-readable storage medium of claim 17, wherein receiving the at least one image of the listener environment comprises receiving a multi-view capture of the listener environment.

20. The computer-readable storage medium of claim 17, wherein the listener environment comprises a first environment, wherein the audio comprises a first echo property associated with a second environment, and wherein generating the updated audio comprises:
updating the first echo property to a second echo property associated with the first environment.
